(19) United States
(12) Patent Application Publication
(10) Pub. No.: US 2008/0023404 A1
(43) Pub. Date: Jan. 31, 2008

(54) CONCRETE FILTERING SYSTEMS AND METHODS

(76) Inventor: Gregory Majersky, Denver, CO (US)

Correspondence Address: HOLLAND & HART, LLP, P.O BOX 8749, DENVER, CO, 80201, US

(21) Appl. No.: 11/831,761

(22) Filed: Jul. 31, 2007

Related U.S. Application Data
(60) Provisional application No. 60/834,553, filed on Jul. 31, 2006.
(60) Provisional application No. 60/913,029, filed on Apr. 20, 2007.

(51) Int. Cl. C02F 1/00; B01D 37/00; C02F 1/28; B01D 39/20

(52) U.S. Cl. 210/683; 210/496; 210/501; 210/502.1; 210/504; 210/748; 210/749; 210/767; 210/805

(57) ABSTRACT

There are disclosed a water filter, a method and a system for producing potable water. In an embodiment, the water filter includes a pervious concrete section having an input portion and an output portion. Input portion provides unfiltered water to the section. Output portion receives filtered water from the section and provides the filtered water to a location for collection. In one embodiment, the method includes providing unfiltered water to an input portion of a pervious concrete section of the filter, receiving filtered water from an output portion of the filter, and providing the filtered water to a location for collection. In another embodiment, the system includes a water filter having a pervious concrete section with an input portion and an output portion, a storage portion for providing unfiltered water to the input portion, and a collector portion for receiving filtered water. Other embodiments are also disclosed.

### REFERENCE TO PENDING PRIOR PATENT APPLICATIONS

This patent application claims benefit of (1) pending prior U.S. Provisional Patent Application Ser. No. 60/834,553, filed Jul. 31, 2006 by Gregory Majersky for CONCRETE FILTERING SYSTEMS AND METHODS, and (2) pending prior U.S. Provisional Patent Application Ser. No. 60/913,029, filed Apr. 20, 2007 by Gregory Majersky for CONCRETE FILTERING SYSTEMS AND METHODS, which patent applications are hereby incorporated herein by reference.

### BACKGROUND

Approximately 65 to 70% of the rural population in developing areas of the world do not have access to a safe source of water. See, for example, Water Partners International (2006). Water Related Facts. http://www.water.org/resources/disease.htm. Accessed March 2006. In addition, more than five million people die from water-related disease. See, for example, Pacific Institute, (2002). “Dirty Water: Estimated Deaths from Water-Related Diseases 2000-2020.”. These facts substantiate the need to provide clean drinking water to a large portion of the world's population. In fact, one of the report authors has personally witnessed people drinking from sewage and contaminated canals in the MinHang district of Shanghai, China. This observation reinforces the need to examine possible methods of providing suitable drinking water in developing communities of the world. The need to supply clean drinking water can be emphasized by the following facts:

The World Health Organization estimates that 80% of all sickness in the world can be contributed to non-potable water and sanitation. See, for example, The Washington Post (1997). “Battling Waterborne Ills in a Sea of 950 Million,” The Washington Post, February 1997.

If no action is taken to provide suitable means of obtaining clean drinking water, as many as 135 million people will die from water-related diseases by 2020. See, for example, Pacific Institute, (2002). “Dirty Water: Estimated Deaths from Water-Related Diseases 2000-2020.”.

Data relating water, sanitation, and hygiene intervention has shown a decrease in sickness from diarrhea by 25-33%. See, for example, Esrey, S. A., Potash, J. B., Roberts, L., and Shiff, C. (1991). “Effects of Improved Water Supply and Sanitation on Ascariasis, Diarrhea, Dracunculiasis, Hookworm Infection, Schistosomiasis, and Trachoma.” World Health Organization. 69(5), pp. 609-621.

Obtaining water for drinking and irrigation in rural areas has always provided a challenge to those who live far away from heavily populated areas. In ancient times, the task of acquiring clean water may have actually been easier due to the lack of centers of industry, large scale agriculture and relatively sparse populations who ate food free of artificial chemicals. Over time, the waste products of these processes have managed to contaminate both ground and surface water.

This leaves microbial infection as the only threat that has remained constant throughout history, and due to the increase of the human population in general, one would naturally expect an increase in the population density of many rural populations in both developing and developed countries.

Typically, water in rural areas is collected from wells or from surface water. Surface water is easier to access, but may be higher in microbial content because it is also accessible by animals and humans for bathing and waste removal; and since the industrial revolution surface water has become necessary for a multitude of processes, as well as waste removal.

Well water on the other hand, is less accessible (except artesian wells) and less prone to be polluted by waste products, but that water is not pure and still can harbor quantities of microbes dangerous to humans. However, well water is an important source of water for many rural populations because groundwater deposits can be extremely large and exist where no apparent surface water is present. Las Vegas, Nevada and Phoenix, Arizona are prime examples of how plentiful groundwater sources can be in desert climates. The purpose of this proposal is to introduce simple technology that may be able to remove enough bacteria from water in rural areas to enhance the health and quality of life for rural populations around the world.

Overview of Other Low Cost and Low Energy Purification Technologies

Chlorine is a widely available chemical available in tablet form that dissolves easily in water. Small amounts of chlorine are effective against most types of bacteria and in these concentrations chlorine is generally not harmful to humans. Chlorine has some disadvantages in that pathogens such as cysts (microorganisms in protective shells) and viruses require concentrations of chlorine high enough to be a danger to humans. Chlorine is also a hazardous substance that even in pill form should not come in to contact with living tissue. There may be some concern as to the hazards of long term exposure to chlorine as well. In urban water treatment plants chlorine is removed from treated water before consumption and discharge for this reason.

Using old fabric for filtration has shown to significantly reduce bacteria counts and remove visibly unattractive sediments. Natural fabrics will swell and absorb water as it is poured through the fabric, trapping bacteria and sediments, there may also be a reduction in chemical concentrations in water treated in this fashion as well. However, the economic condition of people who use this method is often very poor, so old clothing that is used to treat water must be replaced by buying or making new clothing, something that may not be consistently economic feasible. Also, the cloth filters will retain the trapped contaminants and must be washed separately in clean water (which will become polluted) to maintain usefulness.

Solar disinfection is very useful in areas where there is high UV exposure and is very affordable, requiring only a plastic bottle with a cap to hold the water while UV radiation and high temperatures kill organisms. However, the chemical composition of the water does not change, cloudy weather almost nullifies the effectiveness of solar radiation in treating water, viruses and parasites may not be significantly affected and there may be some evidence that volatile organic compounds (VOCs) in the plastic constituting the containers may leach into the water as a result of high temperatures and high radiation. Additionally, the containers used for solar disinfection are typically plastic jugs. The fabrication of these jugs is not yet environmentally friendly and the jugs do not decompose, they must be recycled IF such facilities are available. Plastic also may become contaminated with organic pollutants in the water.

Organic Treatments, including plants like the Moringa oleifera tree, may provide materials which may act as filters and have chemical properties capable of killing microorganisms. When handled correctly, these sources may provide effective filtration and treatment of water for consumption. However, the presence of these plants is geographically specific and human populations may not live in close proximity to such plants. Additionally, these plants or their seeds, leaves bark or fruit must be harvested and used in a sustainable manner to ensure continued survival of this source and to prevent an upset of the local ecosystem. Unfortunately, the water demands of the local population may be greater than what sustainable harvesting of such local plants can provide, creating a situation where the plant resource may be depleted or the local population may be impacted by the lack of sufficient potable water.

Sand filtration using sand columns has become popular due to the effectiveness of sand in removing bacteria and other pollutants, as well as the general availability of sand. However, sand filters must be backwashed everyday to maintain effectiveness. This requires the use of clean water that may already be in short supply if raw water resources are scarce. Effective sand filters are large and to wash the filter in a timely manner requires not only sufficient clean water but the ability to provide sufficient pressure, which rural and economically developing communities may not be able to do.

### SUMMARY OF THE INVENTION

In an embodiment, there is provided a water filter for producing potable water, the water filter comprising a pervious concrete section having an input portion and an output portion, the input portion for providing unfiltered water to the pervious concrete section, and the output portion for receiving filtered water from the pervious concrete section and providing the filtered water to a location for collection as the potable water.

In another embodiment, there is provided a method of producing potable water with a filter, the method comprising providing unfiltered water to an input portion of a pervious concrete section of the filter, receiving filtered water from an output portion of the pervious concrete section of the filter, and providing the filtered water to a suitable location for collection as the potable water.

In yet another embodiment, there is provided a system for producing potable water, the system comprising a water filter having a pervious concrete section with an input portion and an output portion, a storage portion for providing unfiltered water to the input portion of the pervious concrete section, and a collector portion for receiving filtered water from the output portion of the pervious concrete section so as to provide the potable water.

Other embodiments are also disclosed.

### BRIEF DESCRIPTION OF THE DRAWINGS

Illustrative embodiments of the invention are illustrated in the drawings, in which:

FIGS. 1A and 1B illustrates pervious concrete and conventional concrete, respectively;

FIG. 2 illustrates an example of Escherichia coli (E. coli) bacteria;

FIG. 3 illustrates the concentrations of iron, aluminum, and magnesium for the seven samples taken during the erosion testing;

FIG. 4 illustrates a water sample poured onto the surface of a pervious concrete filter;

FIG. 5 illustrates concentrations of metals After erosion study;

FIGS. 6A and 6B illustrate the laboratory analysis results for bacterial dissolved oxygen for an unsieved filter and a sieved filter, respectively;

FIG. 7 illustrates dissolved oxygen and temperature measurements;

FIGS. 8A and 8B illustrate dissolved oxygen results and the temperature difference results for the unsieved filters, respectively;

FIGS. 9A and 9B illustrate dissolved oxygen results and the temperature difference results for the sieved filters, respectively;

FIGS. 10A and 10B illustrate the percent removal of metals for the unsieved and the sieved filters;

FIG. 11 illustrates the percent removal of sodium for the unsieved and the sieved filters;

FIGS. 12A-13E and 13A-13C illustrate various exemplary pervious concrete sections for a water filter; and

FIGS. 14A-14C illustrate a system for producing potable water

### DETAILED DESCRIPTION

In various embodiment, there are provided filters and methods that may filter contaminated water; thus producing safe drinking water to those in need. There is provided a filter formed with a non-conventional filter material. Permeable or pervious concrete has traditionally been used in producing pavement structures. This type of concrete has been applied in parking lots and green roofing projects to improve the quality of rain water before it enters urban drainage systems. See, for example, Haselbach, L. M. and. Freeman, R. M. (2006) “Vertical Porosity Distributions in Pervious Concrete Pavement.” Materials Journal Vol. 103, No. 6, November-December 2006, pg. 452-459. See also, Park, S., (2002). Chungnam National University, Daejeon, Republic of Korea; Mang Tia, University of Florida. “An experimental study on the water-purification properties of porous concrete”, USA; 19 Nov. 2002. Pervious concrete may be formed as a hardened mixture comprised of water, cement, and gravel. Generally, the pervious concrete mixture has little to no sand. With the absence of sand, voids are present to allow water to flow through the concrete structure. Various embodiments herein specify shape, size, and effective gravel size to successfully filter contaminates from non-potable water.

Concrete was chosen due to its wide use and availability throughout the world and the fact that it has been used by mankind for construction for thousands of years. Global expertise in working with this material is present and sufficient. Supply and production infrastructure are already in place. No additional energy is required to create systems to produce this traditional material already used worldwide. As a result, no additional pollution is added into the environment.

The pervious concrete filter addresses the everyday lack of clean drinking water in many countries and has the potential to provide drinking water in flooded areas, where potable water infrastructure may be rendered inadequate. This filter can help maintain economic growth by improving overall public health and morale by providing improved drinking water quality. Sickness and fatality can be reduced by this low cost solution to improving water quality.

The concrete filters may be able to remove enough bacteria from water in rural areas to enhance the health and quality of life for rural populations around the world. In addition, a globally omnipresent and recyclable material in concrete can be used to remove single celled organisms from water. The constituent materials for concrete exist all over the world.

The concrete filter provides an effective water filtration system using an ancient man-made material, concrete. The concrete filter may take advantage of the advances in pervious concrete technology and applications to provide a readily available material to produce potable water. Target populations are rural areas and suburban areas of cities without sufficient water treatment facilities. Four aspects of sustainability are addressed in these areas: (1) appropriate technology, (2) ecosystem sustainability, (3) environmental sustainability, and (4) socio-economic sustainability.

Pebbles, sand and other materials may be used to effectively remove 2 micrometer diameter bacteria from water. Construction of the concrete filters may be done locally and by hand or maximize efficiency of centralized production and distribution. Cleansing or recycling of the concrete filter may be performed once it has become clogged with impurities with minimal environmental impact.

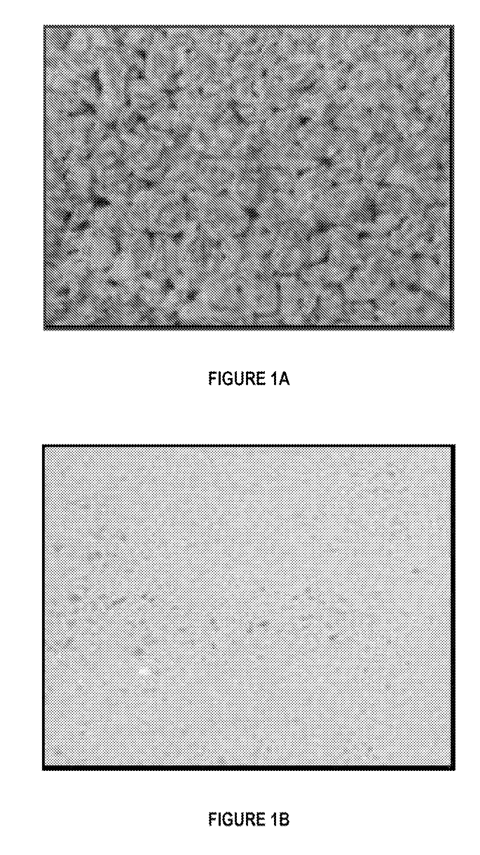

Pervious concrete is a construction material that offers numerous economical and environmental benefits. Pervious concretes, like conventional concrete consists of Portland cement, water, and aggregates. The increased porosity of this material is achieved by eliminating the sand from the concrete mixture. By reducing the amount of sand in the mixture, air voids are created in the concrete allowing water to pass through the concrete. Pervious concrete has approximately a 15-25% void structure allowing between 3 to 8 gallons of water per minute to pass through one square foot section of concrete. National Ready-Mixed Concrete Association, NRMCA, (2005). “Pervious Concrete: When it Rains, it Drains.” National Ready-Mixed Concrete Association, Silver Spring, Md. Pervious concrete may also be recycled at the end of the designed life. The porous nature of pervious concrete when compared to conventional concrete is shown in FIGS. 1A and 1B.

Concrete has been identified as an ideal material for filtering water, at least for organisms larger than a virus. Concrete may include basic materials, such as pebbles, mud and sand. The four aspects of sustainability identified above are addressed herein-below.

One aspect is cost. The labor needed to produce concrete is fairly non-specialized and does not require a high level of education. Cement is the only component that needs to be produced in a factory, however, the production technology is basic and the ingredients are fairly low-cost. Secondly, materials may consist of sand and pebbles, the glue that holds them together. Concrete may also be easily produced from a combination of other common materials found in the earth's crust. No container is required to hold the material together, as in a sand filter. Thirdly, in order to meet sustainability goals, the concrete filter periodically needs to have impurities removed. To accomplish this, the material can either be recycled (though that requires more energy) or, due the durability of the material, can be exposed to locally available chemicals and solar radiation. Finally, once the cement, pebbles and sand are made available, local human power can mix and pour the concrete into locally made frames. The entire filter assembly may also be assembled by local labor for a quick transition from delivery to drop off.

Sustainable developments in water quality technologies are widespread. The use of ozone, UV light, advanced filtration and biotechnology represent the cutting edge in efficiency and effectiveness in removing pollutants, but each requires significant amounts of energy, expensive facilities to house the specialized equipment and an educated workforce to maintain proper operation. Less advanced technologies listed in the following pages approach pure sustainability, but have their own limits due to weather (solar heat), toxicity (chlorine and solar heat), availability of materials (Moringa oleifera), the expense, effort or use of valuable clean water in replacing/cleaning material (sari cloth and sand filters), or needing a container, most likely made of artificial material such as plastic (sand filters). Additionally, use of plastic in high temperature environments may increase organic compound concentrations in the water.

Sustainable technologies should require a minimum of non-human energy and be able to use locally available materials for fabrication, use and cleaning. Sustainable water treatment should also require little or no formal education to maintain the system. It is believed the use of porous concrete filters meets these sustainable requirements.

### Fabricating Porous Concrete

Porous concrete may be fabricated in the same manner as normal concrete, but generally with less sand or fly-ash content, as those materials have a much smaller diameter and will fill in spaces between pebbles. The only difference is that the concrete is not finished to provide a smooth surface, which would prevent the flow-through of water. The pore size is determined by a ratio of sand/fly ash to pebbles. After placement, the concrete is compacted with a heavy roller and allowed to cure.

Recycled concrete material from clogged filters may be used as aggregate in new concrete filter systems. Cement is found all over the world. In fact, two of the largest cement producers in the world, Holcim and Lafarge, are located in over 75 countries worldwide. Cement should be readily available in many areas of the world.

Zeolites, which are microporous crystalline solids with well-defined structures, may be included as a material addition to the filter so as to improve removal of chemicals and provide nano-scale porosity to better remove viruses.

Filter Alternatives

Pervious concrete may be chosen as a filter material due to the availability of materials needed to produce concrete filter samples, low fabrication cost, and the ability to recycle the concrete filters once the system became non-effective. Prior to selecting pervious concrete as a filtration material, a review of alternative point-of-use water treatment technologies was conducted. The benefits and disadvantages of each are presented in the following.

Chlorine is a widely available chemical available in tablet form that dissolves easily in water. Small amounts of chlorine are effective against most types of bacteria and in these concentrations chlorine is generally not harmful to humans.

Using old fabric has shown to significantly reduce bacteria counts and remove visibly unattractive sediments. Natural fabrics will swell and absorb water as it is poured through the fabric, trapping bacteria and sediments. The economic condition of people who use this method is often very poor. Old clothing that is used to treat water must be replaced by buying or making new clothing, something that may not be economically feasible. Also, the cloth filters will retain the trapped contaminants and must be washed separately in clean water (which will become polluted) to maintain usefulness.

Sand filtration has become popular due to the effectiveness of sand in removing bacteria and other pollutants, as well as the general availability of sand. However, rapid sand filters must be backwashed everyday to maintain effectiveness, which limits their effectiveness in areas lacking the electrical power necessary to run the backwash pumps.

Each of these above-identified approaches has a number of advantages and disadvantages. This suggests that that a combination may provide a reliable, cost-effective, and environmentally responsible approach to point-of-use water treatment. The goal of this study is to investigate pervious concrete as a complimentary approach that would take advantage of two distinct features:

Pervious concrete filters are unsaturated, unlike cloth or sand filtration. This introduces an air-water interface that may provide treatment analogous to that in a trickling filter. The cement itself may provide treatment through its interaction with the trickling water, representing a second qualitative difference with respect to other filter materials.

As shown in Table 1, the cost to produce a pervious concrete filter is relatively inexpensive. The cost of a single pervious concrete filter with the dimensions of 10 in.×10 in.×18 in. is about $2.45. This cost includes only materials expenses for cement, rock, and water. Cost associated with mixing the concrete mixture was excluded since the sample could easily be mixed by hand.

Additionally, not all locations around the world will have the industrial infrastructure necessary to produce chemical forms of water treatment. Developing areas may not be able to produce the required amount of potable water for an entire community. The necessary industrial infrastructure required to mass produce pervious concrete filters is already present in many of these areas. Table 2 provides cost estimates of the pervious concrete filter and currently available filter materials. See, for example, Existing water filtration methods, (2007), http://www.consumersearch.com/www/kitchen/water-filters/index.html?source=ad words&gclid=CNzGkqCRqlsCFRG3hgodhEbneQ. In addition, the estimated life of the filter is included.

TABLE 1
Materials Cost for Pervious Concrete Filter

| Sample Size | 1.04 | cf | Amount ($US) |
|---|---|---|---|
| Cement | 21.2 | lb | 1.27 |
| Rock | 130.7 | lb | 1.18 |
| Water | 7.2 | lb | 0.002 |

| | |
|---|---|
| Pervious Concrete Filter | 2.45 |
| Materials Cost = | |

TABLE 2
Filter Cost [Existing Water Filtration Methods, 2007]

| | | Estimated | |
|---|---|---|---|
| Filter Method | Cost ($US) | Life of Filter | |
| Pervious Concrete | 2.45 | 2-4 | Months |
| Activated Carbon Cartridge | 15.00 | 1 | Month |
| 5-15 Micron Fabric | 511.75 | 3-6 | Months |
| Sari Cloth Fabric | <1.00 | <30 | Days |

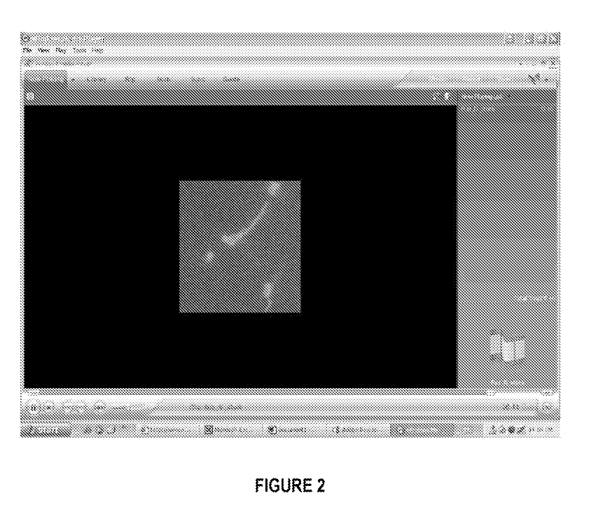

The effects of viscous drag on the linear movement of E. coli. is discussed herein-below. There is shown in FIG. 2, an example of Escherichia coli (E. coli) bacteria that is both deadly for humans and necessary for life. See, for example, http://www.mcb.harvard.edu/NewsEvents/News/Berg.html, accessed July 2006. Without this bacterium, we could not process vitamin K (potassium) or B-vitamins and would quickly die. At the same time, this bacterium can only exist safely on our skin or in our intestines. If it enters any through any other part of our body we quickly succumb to sepsis. See, for example, http://www-micro.msb.le.ac.uk/video/Ecoli.html, accessed July 2006.

E. coli is probably the most commonly studied bacterium due to it's size (averaging 2 um in length and 0.25 um in diameter), it's large flagella, which are also being studied as an inspiration for new nanotechnology based propulsion, and it's simple yet powerful chemical receptors that may be able to detect dangerous compounds. See, for example, http://www.trnmag.com/Stories/071801/Bioengineers_aim_to_harness_bacterial_motion_{—}071801.html, accessed July 2006.

E. coli's motion is especially interesting, as it is able to propel itself forward using it's flagella to coil around the horizontal axis of it's body to achieve linear velocities of up to 10 times each bacterium's body length per second. See, for example, http://www.nature.com/nature/journal/v435/n7046/fig_tab/nature03660_T2.html, accessed July 2006.

For non-linear movement, E. coli is able to fan out it's flagella to form independent rotors that give it 3 dimensional movement similar to how deep sea exploration vehicles use an array of small propellers to provide multidirectional movement. See, for example, http://www.trnmag.com/Stories/071801/Bioengineers_aim_to_harness_bacterial_motion_{—}071801.html, accessed July 2006.

The focus of this invention is currently on E. coli's linear velocity and how the force of viscous drag acts on the bacterium's surface in open water and within a closed channel. By constructing a profile of bacterial velocity and the resulting friction, a nonlinear change is expected in viscous drag as a function of the bacterium's linear velocity. Such a nonlinear change could indicate a meaningful threshold at the level of bacterial motion.

It was necessary to simplify the environment in which the viscous drag on E. coli may be profiled. First, water is chosen as the medium, as it is common in all of E. coli's environments and its viscosity is readily known at various temperatures.

Second, a temperature of 20 degrees Celcius is chosen as a standard temperature as it is approxiamately room temperature for water, and E. coli can be found in tap water as a contaminant. Having considered other temperatures, 0 degrees celcius was not a practical temperature and higher temperatures would only be found inside the human digestive tract, a natural habitat for E. coli, or approaching the boiling point of water, which would kill E. coli and render this study pointless.

Third, the velocity of water is chosen to be 1 um/second as a reasonable assumption to reflect E. coli's natural surroundings. Water flow velocities well in excess of 1 um/sec. would overwhelm E. coli's natural propulsion system, also rendering the purpose of this study useless. The fact is taken into account that E. coli is swimming against (upstream) and with (downstream) the direction of the flow of the water at an angle of 0 degrees to the direction of the water to simplify my calculations.

Lastly, the range of E. coli velocities is chosen to be a range from 1 to 21 um/sec to replicate a realistic environment where E. coli begins at a relative velocity of 0 um/sec to the maximum velocity for a standard E. coli bacterium of 2 um in length and 0.25 um in diameter. See, for example, http://www.rowland.harvard.edu/labs/bacteria/projects_filament.html, accessed July 2007)

As shown in the calculations and the graphs, the prediction of a nonlinear change in viscous drag proved false in open water. However, within a closed channel, the predictions of nonlinear change were proven true. By increasing the channel diameter from 0.3 um to 0.35 um when E. coli is swimming downstream, the force of viscous drag was reduced by almost a factor of 10. When E. coli is swimming upstream, the channel diameter must be increased to a diameter of 0.4 um to realize an equivalent decrease in the force of viscous drag.

Analysis of Poiseuille's Law Variables on Volumetric Flow (FIG. 2)

In the above discussion, the forces of friction and their magnitude of effect on a single E. coli bacterium as it swam in a linear motion through open water and through channels of various diameter were examined. The results showed that friction was not a significant force on an E. coli bacterium until the channel diameter was approximately the diameter of the bacterium. See, for example, http://biosystems.okstate.edu/darcy/LaLoilbasics.htm, accessed July 2006.

The next logical step is to analyze the volume of water that would flow through a single channel based on the previously stated average diameter of an E. coli bacterium which is 0.2 micrometers (μm). See, for example, www.trnmag.com/Stories/071801/Bioengineers_aim_to_harness_batercial_motio n_{—}071801.html, accessed July 2006.

The purpose of a water filter is to remove undesirable elements while being able to provide reasonable quantities of water over a short period of time. No one wants to wait all day for one glass of clean water. Filters typically remove contaminants such as metals, chemicals, colors and other solids. Bacteria are typically killed by chemicals, which can be hazardous, or by processes such as reverse osmosis and mircofiltration. See, for example, http://www.aquapurefilters.com/contaminates/108/bacteria.html, accessed July 2006.

Many of these processes can be dangerous, expensive and difficult to maintain without trained personnel, making them often unobtainable for impoverished communities in both developing and undeveloped nations. The materials that constitute concrete are very cheap and widely available, and many societies have been performing various levels of concrete engineering since the Bronze Age. In addition, concrete is very durable and can take on either solid or porous forms, making it potential very suitable for a filtration medium.

Volumetric flow is evaluated through a straight, non-sloping channel (perpendicular to the surface). This reflects a desire to maintain the simplicity of the calculations as stated in my previous analysis of friction against linear E. coli motion. The initial analysis allows the reader to make cursory judgments of the potential feasibility of the eventual goal of these short research topics which would be the development of a concrete based water filter. With a circular, straight, non-sloping channel, Poiseuille's Law is used. Further analysis generally requires the use of Darcy's Equation, which is applicable for both linear and nonlinear flow. An example calculation of Darcy's Law for the parameters specified in this analysis is included for comparison with Poiseuille's Law. To maintain consistency water temperature is kept at 20 degrees Celcius per the previous analysis.

Based on the results of theoretical friction on a single E. coli bacterium in a closed channel of 20 C water, 3 variables from Poiseuille's Law are selected to analyze. The first variable was the radius of the channel, as the average E. coli's diameter is 0.2 μm, A range of diameters was chosen from 4 μm to 1 μm. The second variable that was analyzed was length of the channel. Due to fairly rapid decreases in volumetric output with respect to length, a value range of 1 to 5 centimeters (cm) was used. The third variable was height of the column of water over the channel. It was known in advance that a large column of water would be needed to provide the pressure to create respectable volumetric output, therefore a value range of 0.5 to 5 meters is chosen.

Taking into account the fact that a 0.2 μm diameter (radius=0.1 μm) is used to effectively trap an average E. coli bacterium, volumetric flow increases inversely with the length of the channel L and volumetric flow increases exponentially with the height of the water column h. The following parameters are chosen: r=0.1 μm, L=1.0 E-02 meters, h=2 meters. The resulting volumetric output was 2.77E-16 m3 per hour. Over the course of 24 hours the output is 6.64 E-15 m3 per day for one channel. If the filter is 50 m2 in size and the surface is 50% pores, the resulting volumetric output is 1.6 E+05 m3 per day per Poiseuille's Law. Using the same parameters in Darcy's equation, the volumetric output is 7.05 E+11 m3 per day.

Exemplary calculations are provided as follows:

flow rate = ((Pi/8) * (((density of water * gravitational
acceleration{down} * height of the water column above
pore)/length of pore)/viscosity of water) * radius of
pore to the 4th power) * 3600 = cubic meters/hour

| | |
|---|---|
| 3.93E−01 | Pi/8 |
| 9.80E+03 | water density * gravity |
| 2.00E+00 | height of water column above pore (meters) |
| 1.00E−02 | length of pore (meters) |
| 1.00E−03 | Viscosity of pure water at 20 degrees C |
| 2.00E−07 | radius of pore (meters) |
| 1.60E−27 | radius of pore (meters) to the 4th power |
| 3.60E+03 | converts seconds to hours |

trial 1
h = 2 meters, L = 0.01 meters, measure flow output with respect to r when
5.0E−8 <= r <= 2.0E−07

| | | | |
|---|---|---|---|
| 4.43E−15 | cubic meters per | radius = 2.00E−07 meters | 2.00E−07 |
| | hour | length of pore = 1.00E−02 | |
| | | meters | |
| | | height of water column = | |
| | | 2.00 meter | |
| 1.40E−15 | cubic meters per | radius = 1.50E−07 meters | 1.50E−07 |
| | hour | length of pore = 1.00E−02 | |
| | | meters | |
| | | height of water column = | |
| | | 2.00 meter | |
| 2.77E−16 | cubic meters per | radius = 1.0E−07 meters | 1.00E−07 |
| | hour | length of pore = 1.00E−02 | |
| | | meters | |
| | | height of water column = | |
| | | 2.00 meter | |
| 1.73E−17 | cubic meters per | radius = 5.0E−08 meters | 5.00E−08 |
| | hour | length of pore = 1.00E−02 | |
| | | meters | |
| | | height of water column = 2.00 | |
| | | meter | |

trial 2
h = 2 meters, r = 2.00E−07 meters, measure flow output with respect to L
such that 0.01 <= L <= 0.05 meters in length

| | | | |
|---|---|---|---|
| 4.43E−15 | cubic meters per | radius = 2.00E−07 meters | |
| | hour | length of pore = 1.00E−02 | 1.00E−02 |
| | | meters | |
| | | height of water column = | |
| | | 2.00 meter | |
| 2.22E−15 | cubic meters per | radius = 2.00E−07 meters | |
| | hour | length of pore = 2.00E−02 | 2.00E−02 |
| | | meters | |
| | | height of water column = | |
| | | 2.00 meter | |
| 1.48E−15 | cubic meters per | radius = 2.00E−07 meters | |
| | hour | length of pore = 3.00E−02 | 3.00E−02 |
| | | meters | |
| | | height of water column = | |
| | | 2.00 meter | |
| 1.11E−15 | cubic meters per | radius = 2.00E−07 meters | |
| | hour | length of pore = 4.00E−02 | 4.00E−02 |
| | | meters | |
| | | height of water column = | |
| | | 2.00 meter | |
| 8.87E−16 | cubic meters per | radius = 2.00E−07 meters | |
| | hour | length of pore = 5.00E−02 | 5.00E−02 |
| | | meters | |
| | | height of water column = | |
| | | 2.00 meter | |

trial 3
L = 0.01 meters, r = 1.00E−07 meters, measure flow output with respect
to h such that 1.0 <= h <= 4 meters in length (given r can trap the average
E. coli bacterium

| 6.93E−17 | cubic meters | radius = 1.00E−07 meters | |
|---|---|---|---|
| | per hour | length of pore = 1.00E−02 | |
| | | meters | |
| | | height of water column = 0.05 meter | 0.05 |
| 1.39E−16 | cubic meters | radius = 1.00E−07 meters | |
| | per hour | length of pore = 1.00E−02 | |
| | | meters | |
| | | height of water column = 1.00 meter | 1.00 |
| 2.77E−16 | cubic meters | radius = 1.00E−07 meters | |
| | per hour | length of pore = 1.00E−02 | |
| | | meters | |
| | | height of water column = 2.00 meter | 2.00 |
| 4.16E−16 | cubic meters | radius = 1.00E−07 meters | |
| | per hour | length of pore = 1.00E−02 | |
| | | meters | |
| | | height of water column = 3.00 meter | 3.00 |
| 5.54E−16 | cubic meters | radius = 1.00E−07 meters | |
| | per hour | length of pore = 1.00E−02 | |
| | | meters | |
| | | height of water column = 4.00 meter | 4.00 |

Daily Flow Rate
1 sq. Meter filter, 40% of the surface area is porous
Hourly flow rate for 1 pore (2E−8 dia., 1 cm long, 2 meter high
water column): 4.43E−15 cu.meters/hour

| | | |
|---|---|---|
| Surface Area | 1 | sq. meter |
| Pore volume | 40 | % |
| Pore | 3.14E−12 | sq. cm |
| area | | |
| Flow rate for one | 4.43E−15 | cu. Meter/hour |
| pore | | |
| 1.35E+00 | cubic meters | |
| | per day | |

These calculations demonstrate that theoretically a concrete filter with pore diameter sufficient to trap an average diameter E. coli bacteria These calculations demonstrate that pervious concrete filters can be fabricated as regular concrete but without fine grained materials. These calculations demonstrate the ease and simplicity in fabrication of these samples does not require special training and special fabrication materials. These calculations examine the pervious concrete filter effectiveness in improving overall water quality for consumption or other uses. These calculations investigate the hypothesis that eliminating gravel larger than 0.25 inches (which is referred to herein-below as “sieved”) is more effective in bacteria and inorganic compound removal than an unsorted composition of coarse grains (unsieved) when the filter dimensions were identical.

The filters were tested by measuring water samples contaminated with bacteria and metals before and after the water passed through the pervious sample. The scope of this research was limited to the use of less hazardous materials in order to reduce the risk of injury or impairment to research personnel and minimize possible contamination of the laboratory environment.

The bacteria used for coliform research was Micrococcus luteus. This species has a size range of 0.5 to 3.5 micrometers and average size of 2.0 micrometers. See, for example, Landau, N. (2002) “Mass of bacteria.” Online posting. Mon. Apr. 8, 2002. www.bio.net/bionet/mm/microbio/2002-April/021407.html. These size parameters allow for this bacteria as a suitable replacement for potentially more hazardous E. coli species. Diluted solutions of Micrococcus luteus were prepared at 25, 30, 35, 40 and 45 mg of stock/L of deionized water. These samples were then measured for optical density as Total Suspended Solids (TSS). To simulate inorganic contamination and measure desalinization potential, solutions of increasing concentrations of sodium, iron, and copper were prepared.

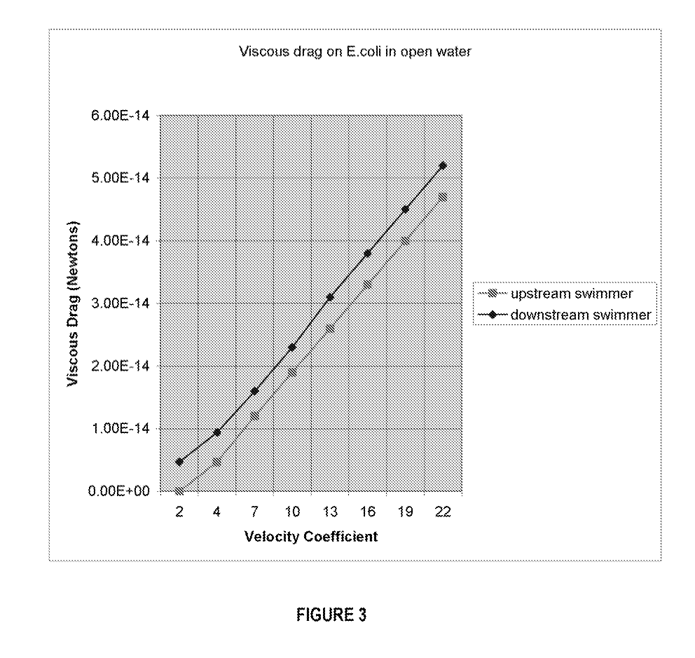

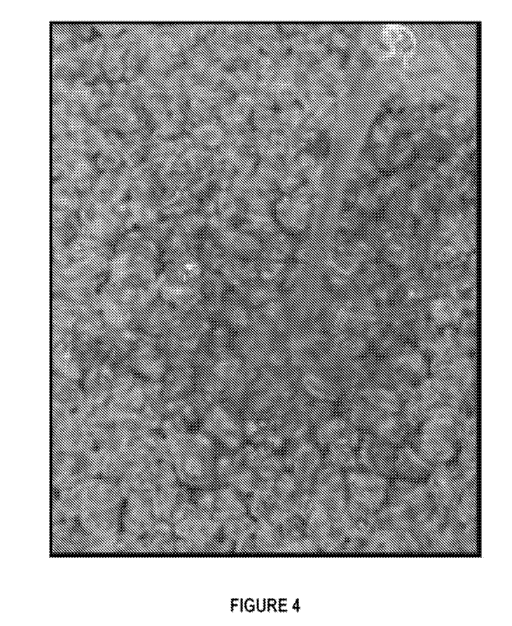

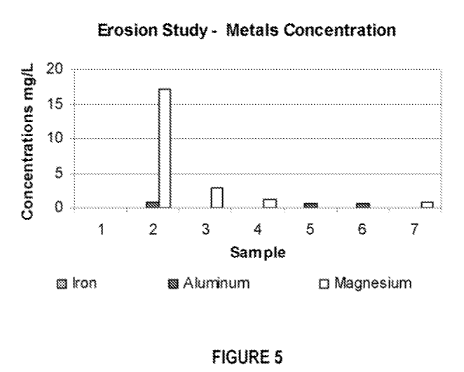

The first test performed was an erosion test. The metals analyzed included iron, aluminum, magnesium as total recoverable metals. Each test was performed for 5 minutes. All quantities, unless otherwise specified below, are given as mg/L. This was to examine how much, if any, cementations material or aggregate would be physically removed by the presence of flowing water. Initially, the first three tests produced slightly turbid water with a small amount of pebbles. As a result of this test, the filter was flushed with cold tap water for 70 minutes at a flow rate of 1 L/hr. Laboratory analysis of samples taken from the erosion test were measured for metals concentrations and pH at Evergreen Analytical in Lakewood, Colo. with an Inductively Coupled Plasma (ICP) instrument. The erosion test samples were analyzed for total recoverable metals, with the primary focus being iron, aluminum, and magnesium. Samples 2, 3, and 4 experienced higher than expected levels of magnesium. Samples 4-7 were taken after the filter was rinsed for 1 hr. 10 minutes with cold tap water at 1 L/hour Results showed that both iron and aluminum concentrations were within the Environmental Protection Agency (EPA) secondary maximum concentration limits (MCLs) for drinking water. See, for example, EPA (2007), Online publication, http://www.epa.gov/safewater/standards.html. FIG. 3 shows the concentrations of iron, aluminum, and magnesium for the seven samples taken during the erosion testing. For example, FIG. 4 illustrates a water sample being poured onto the surface of the pervious concrete filter. FIG. 5 graphically illustrates concentrations of metals after the erosion study.

TABLE 3
Materials Cost for Pervious Concrete Filter

| | | | | EPA Secondary | |
|---|---|---|---|---|---|
| Sample | Iron | Aluminum | Magnesium | MCLs | pH |
| 1 | <0.35 | <0.35 | <0.35 | Iron | 12.13 |
| 2 | <0.35 | 0.741 | 17.1 | 0.3 | 12.37 |
| 3 | <0.35 | <0.35 | 2.88 | | 12.35 |
| 4 | <0.35 | <0.35 | 1.16 | Aluminum | 11.82 |
| 5 | <0.35 | 0.58 | <0.35 | 0.05 to 0.2 | 11.45 |
| 6 | <0.35 | 0.681 | <0.35 | | 11.61 |
| 7 | <0.35 | <0.35 | 0.879 | Magnesium | 11.72 |
| | | | | no MCL | |

Bacterial testing was performed on the sieved and unsieved filters. These tests were conducted to provide a comparison of filter performance between the unsieved vs. sieved filters. The bacterial filtration results are shown in Table 4.

TABLE 4
Bacterial Filtration Results

| | Unsieved Filter | | Sieved Filter | |
|---|---|---|---|---|
| Stock | Pre- | Post- | Pre- | Post- |
| Dilutions | Filtration | Filtration | Filtration | Filtration |
| mL/500 mL | TSS (mg/L) | TSS (mg/L) | TSS (mg/L) | TSS (mg/L) |
| 25 | 100 | 0.000001 | 137 | 0 |
| 30 | 134 | 0.000002 | 175 | 0 |
| 35 | 141 | 0 | 191 | 0.000001 |
| 40 | 177 | 0.000001 | 251 | 0 |
| 45 | 174 | 0 | 265 | 0 |

Pre-filtration and post-filtration dissolved oxygen (DO) measurements were taken to measure oxygenation abilities of the unsieved and sieved filters. The sieved filter produced an average of 0.21 mg/L increase in DO levels over the unsieved filter. Percent removal of bacteria was calculated on a mg of bacteria/L basis. One Micrococcus luteus has an average wet weight of 0.6 picograms. See, for example, Landau, N. (2002) “Mass of bacteria.” Online posting. Mon. Apr. 8, 2002. www.bio.net/bionet/mm/microbio/2002-April/021407.html. These size parameters allow for this bacteria as a suitable replacement for potentially more hazardous E. coli species. The filter was successful in removing bacteria from a concentration of about 10⁸ bacterial per mL of water to less than 1 per mL. The percentage of bacterial removal for both filters was well in excess of the EPA primary MCLs for bacteria (99.9%). Table 5 shows the bacterial dissolved oxygen results for the sieved and unsieved filters.

TABLE 5
Bacterial Dissolved Oxygen Results

| | Filter with Unsieved Coarse Aggregate | | | | Filter with Sieved Coarse Aggregate | | | |
|---|---|---|---|---|---|---|---|---|
| Stock | | Pre- | Post- | | | Pre- | Post- | |
| dilutions | Bacterial | filtration | filtration | DO | Bacterial | filtration | filtration | DO |
| mL/500 mL | TSS (mg/L) | DO | D.O. | difference | TSS (mg/L) | DO | D.O. | difference |
| 25 | 100 | 3.87 | 5.30 | 1.43 | 137 | 3.54 | 4.78 | 1.24 |
| 30 | 134 | 3.27 | 4.99 | 1.72 | 175 | 2.70 | 4.48 | 1.78 |
| 35 | 141 | 3.07 | 5.19 | 2.12 | 191 | 2.38 | 4.57 | 2.19 |
| 40 | 177 | 2.26 | 4.70 | 2.44 | 251 | 2.15 | 4.81 | 2.66 |
| 45 | 174 | 3.57 | 4.97 | 1.40 | 265 | 2.13 | 4.41 | 2.28 |

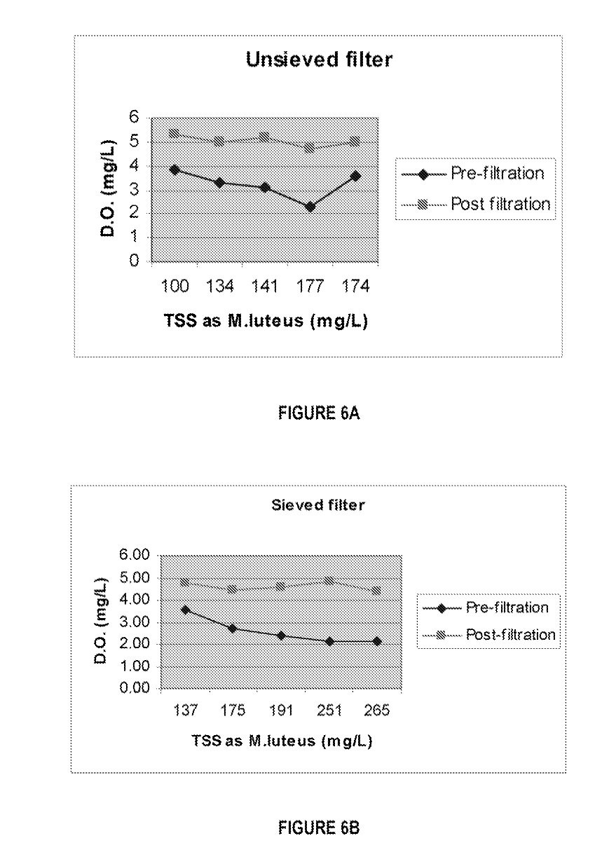

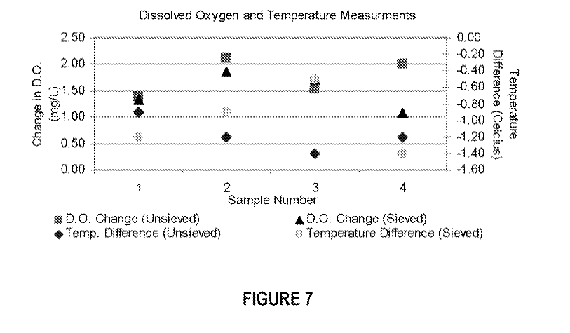

FIGS. 6A and 6B graphically illustrate the laboratory analysis results for bacterial dissolved oxygen for an unsieved filter and a sieved filter as shown above in Table 5. Dissolved oxygen and temperature change measurements were also taken during pre-filtration and post-filtration. The unsieved filter produced a greater increase in D.O. and a greater decrease in water temperature. See FIG. 7.

FIG. 7 graphically illustrates dissolved oxygen and temperature measurements. Table 6 shows another set of bacterial filtration results for the unsieved filters. Table 7 shows another set of bacterial filtration results for the sieved filters.

TABLE 6
Bacterial Filtration Results For Unsieved Filters

| Unsieved Stock | Pre-filtration | Post-filtration | |
|---|---|---|---|
| dilutions | Bacterial TSS | Bacterial TSS | Percent |
| mL/500 mL | (mg/L) | (mg/L) | Removal |
| 25 | 100 | 0.000001 | 1.00E+10 |
| 30 | 134 | 0.000002 | 6.70E+09 |
| 35 | 141 | 0 | Complete |
| 40 | 177 | 0.000001 | 1.77E+10 |
| 45 | 174 | 0 | Complete |

TABLE 7
Bacterial Filtration Results For Unsieved Filters

| Sieved Stock | Pre-filtration | Post-filtration | |
|---|---|---|---|
| dilutions | Bacterial TSS | Bacterial TSS | Percent |
| mL/500 mL | (mg/L) | (mg/L) | Removal |
| 25 | 137 | 0 | complete |
| 30 | 175 | 0 | complete |
| 35 | 191 | 0.000001 | 1.91E+10 |
| 40 | 251 | 0 | complete |
| 45 | 265 | 0 | complete |

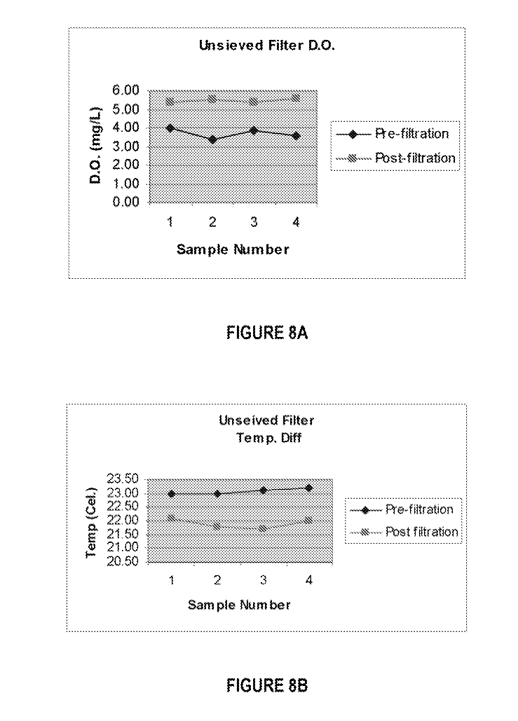

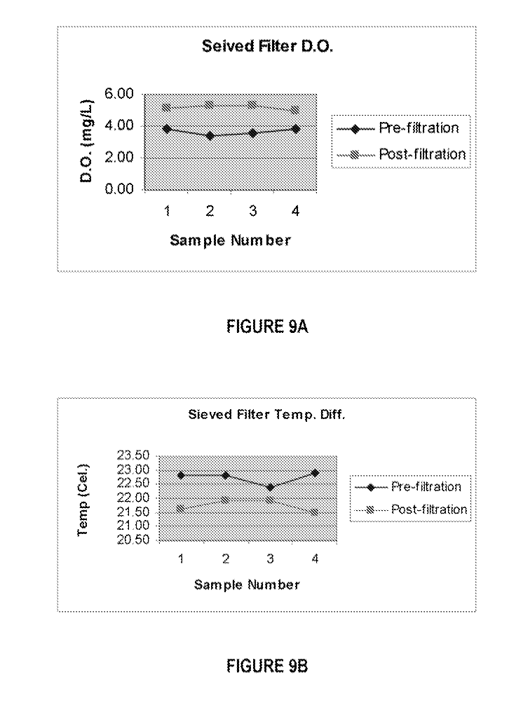

Dissolved metals analysis was performed to evaluate both filters' ability to remove particles smaller than a bacterium (viruses, molecules and atoms) with the hope that this filtration system could provide overall water quality improvements with respect to virus removal, removal of hazardous organic compounds, removal of hazardous metallic elements and possibly partial desalinization. The testing materials that were selected as contaminates included sodium, iron and copper. These contaminates are of minimum toxicity to provide a safe work environment and sufficiently small diameter to allow the results to be extrapolated to more hazardous, larger diameter compounds. Table 8 shows the dissolved metals dissolved oxygen results for the sieved filters. Table 9 shows the dissolved metals dissolved oxygen results for the unsieved filters. FIGS. 8A and 8B graphically illustrate dissolved oxygen results and the temperature difference results for the unsieved filters, respectively. FIGS. 9A and 9B graphically illustrate dissolved oxygen results and the temperature difference results for the sieved filters, respectively.

TABLE 8
Disolved Metals D.O. Results For Sieved Filters

| | | | | Original | New | |
|---|---|---|---|---|---|---|
| | Pre-filtration | Post-filtration | DO | Temp | Temp | Temp |
| Sample # | DO | D.O. | difference | (Cel.) | (Cel.) | Diff. (Cel.) |
| 1 | 3.98 | 5.37 | 1.39 | 23.00 | 22.10 | −0.90 |
| 2 | 3.41 | 5.52 | 2.11 | 23.00 | 21.80 | −1.20 |
| 3 | 3.85 | 5.38 | 1.53 | 23.10 | 21.70 | −1.40 |
| 4 | 3.58 | 5.59 | 2.01 | 23.20 | 22.00 | −1.20 |
| | | Average | 1.76 | | Average | −1.18 |
| | | Difference | | | Difference | |

TABLE 9
Disolved Metals D.O. Results For Unsieved Filters

| | | | | Original | New | |
|---|---|---|---|---|---|---|
| | Pre-filtration | Post-filtration | DO | Temp | Temp | Temp |
| Sample # | DO | D.O. | difference | (Cel.) | (Cel.) | Diff. (Cel.) |
| 1 | 3.81 | 5.14 | 1.33 | 22.80 | 21.60 | −1.20 |
| 2 | 3.42 | 5.28 | 1.86 | 22.80 | 21.90 | −0.90 |
| 3 | 3.58 | 5.29 | 1.71 | 22.40 | 21.90 | −0.50 |
| 4 | 3.84 | 4.92 | 1.08 | 22.90 | 21.50 | −1.40 |
| | | Average | 1.50 | | Average | −1.00 |
| | | Difference | | | Difference | |

The results of the metals analysis found that iron was removed to less than the minimum detection level of the ICP in all but the third trial. The concentration of iron in both cases were in excess of the EPA's secondary drinking water standard of 0.3 mg/L. EPA (2007), Online publication, http://www.epa.gov/safewater/standards.html. The average percent removal of iron by the unsieved filter was 0.15% greater than the sieved filter. Sodium was added to simulate sea water at an average concentration of 35,000 mg/L. The percentage of sodium removed by both filters increased similarly with each successive trial. However, the average percentage of sodium removed by the sieved filter was greater than that of the unsieved filter by 1.13%. The rate of percent increase in sodium removal was 0.074% greater for the sieved filter than the unsieved filter. Table 10 shows the dissolved metals filtration results for the unsieved filters. Table 11 shows the dissolved metals filtration results for the sieved filters.

TABLE 10
Disolved Metals Filtration Results For Unsieved Filters

| | Final | Final | Final | Percent | Percent | Percent | |
|---|---|---|---|---|---|---|---|
| | Cu(2+) | Fe(2+) | Na(1+) | Removal | Removal | Removal | |
| Sample | mg/L | mg/L | mg/L | Cu(2+) | Fe(2+) | Na(1+) | pH |
| 1 | 2.98 | 0 | 10600 | 77.08 | 100.00 | 69.71 | 12.33 |
| 2 | 4.02 | 0 | 9790 | 69.08 | 100.00 | 72.03 | 12.23 |
| 3 | 6.57 | 0.542 | 6950 | 49.46 | 99.46 | 80.14 | 12.08 |
| 4 | 7.47 | 0 | 3840 | 42.54 | 100.00 | 89.03 | 11.88 |
| | | | Average: | 59.54 | 99.86 | 77.73 | |

TABLE 11
Disolved Metals Filtration Results For Sieved Filters

| | Final | Final | Final | Percent | Percent | Percent | |
|---|---|---|---|---|---|---|---|
| | Cu(2+) | Fe(2+) | Na(1+) | Removal | Removal | Removal | |
| Sample | mg/L | mg/L | mg/L | Cu(2+) | Fe(2+) | Na(1+) | pH |
| 1 | 4.07 | 0 | 10300 | 68.69 | 100.00 | 70.57 | 12.5 |
| 2 | 6.43 | 0 | 9110 | 50.54 | 100.00 | 73.97 | 12.52 |
| 3 | 9.25 | 1.17 | 6970 | 28.85 | 98.83 | 80.09 | 12.46 |
| 4 | 8.06 | 0 | 3220 | 38.00 | 100.00 | 90.80 | 12.25 |
| | | | Average: | 46.52 | 99.71 | 78.86 | |

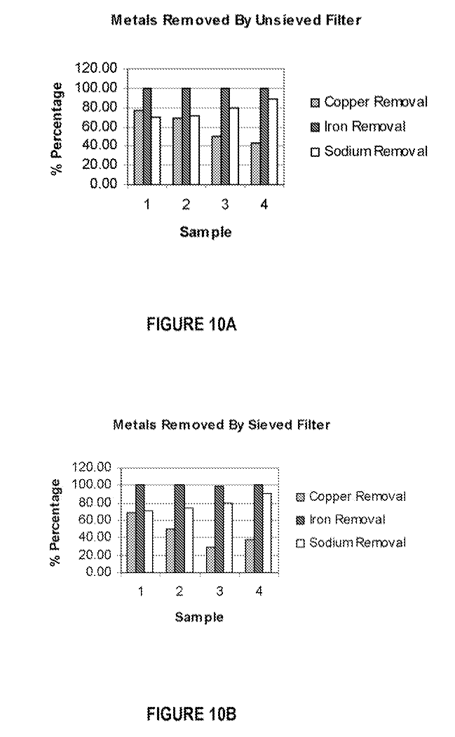

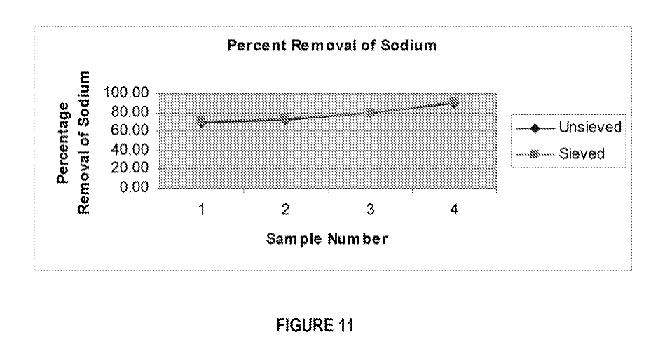

FIGS. 10A and 10B illustrate the percent removal of metals for the unsieved and the sieved filters, respectively. FIG. 11 illustrates the percent removal of sodium for the unsieved and the sieved filters.

In addition, pH was measured for each sample. The range of pH of the filtered water was 11.45 to 12.52. This very high level of pH is a concern and will be further investigated. However, polluted waters and industrial waters are typically acidic. Accordingly, the polluted waters or the industrial waters may be at least partially neutralized with the pervious concrete filter as the cement may increase the pH (provided decreased acidity).

Economic opportunities are created as a result of the need for fabrication of the concrete filters in these areas. Concrete is a recyclable material providing for both environmental and economical benefits. Infrastructure is already in place around the world to produce concrete, thus little or no additional effort is needed to produce pervious concrete filters. New construction is not required in the production of these filters resulting in no significant increase in energy consumption.

Preliminary results demonstrated that the filter was effective for filtering bacteria; however, some other chemical pollutants may increase in concentration, particularly pH. Additional testing is needed to evaluate some of the unsuccessful factors discussed below.

Unsuccessful factors include an unexplainable increase in dissolved copper concentrations (from 2 to 9 mg/L) and a very high pH (11 to 12). The high pH levels in the test samples are likely the result of large concentrations of hydroxide compounds in Portland cement, which generally makes the water non-potable. However, the high pH of the water may be offset by the fact that polluted natural waters and industrial waste water are typically acidic, with a pH level less than 6. See, for example, Grippo, R. S. and Dunson, W. A. (2006) “Interactions between trace metals and low pH in reconstituted coal mine-polluted water.” Online posting. Copyright 2006 http://cat.inist.fr/?aModele=afficheN&cpsidt=2482629. See also, Lenntech (1998). Water treatment & Air Purification Holding B.V. Online Posting Copyright® 1998-2006 www.lenntech.com/water-pollution-FAQ.htm

The initial dissolved copper concentrations were designed to be 0.13, 1.3, 13 and 130 mg/L; however, analytical results determined that 13 mg/L of copper was found in all four samples. In addition, dissolved copper concentrations in the samples indicate an increase in copper passing through the filter. Further testing may be conducted to evaluate copper concentrations and removal using this type of filter.

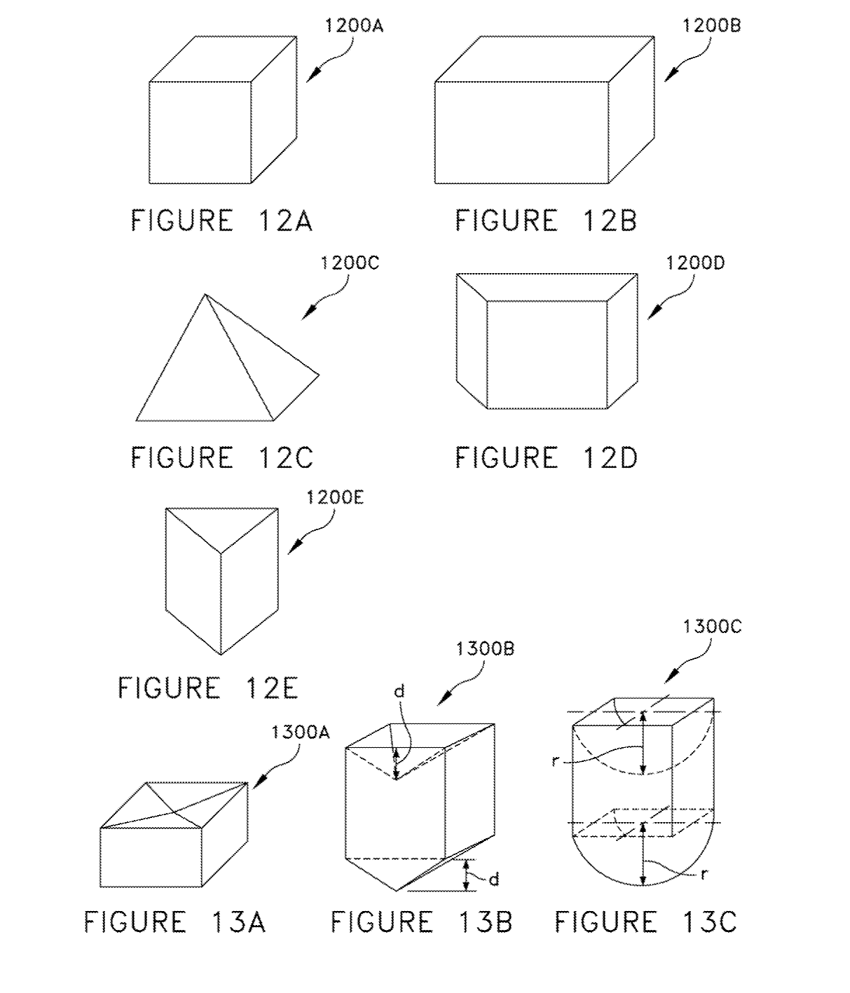

Looking at FIGS. 12A-12E and 13A-13C, there are shown various exemplary pervious concrete sections 1200A-1200E and 1300A-1300C. Pervious concrete sections 1200A-1200E include some efficient storage shapes. Section 1200A has the shape of a cube. Section 1200B has the shape of a rectangular box. Section 1200C has the shape of a pyramid. Section 1200D has the shape of a trapezoidal box. Section 1200E has the shape of a triangular box. Altered ones of sections 1200A-1200E may include sections 1300A-1300C having a smaller area with a contour or other shape on the input portion so as to improve the flow rate. A substantial pressure may be created on the smaller area while allowing a substantially similar volume of filtering. The dimensions of sections 1300A-1300C may be configured to allow interlocking storage of similar ones of pervious concrete sections 1300A-1300C

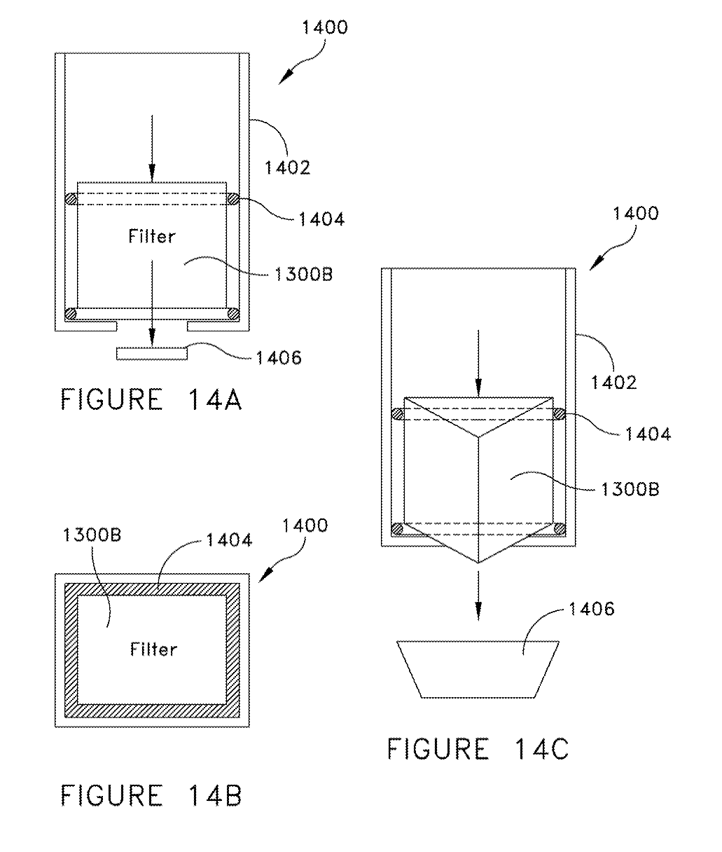

Referring to FIGS. 14A-14C, and in an embodiment, there may be provided a system 1400 for producing potable water. System 1400 may include pervious concrete section, such as section 1300B, a storage portion 1402, an optional waterproof gasket 1404, and a collector 1406. Water filter may include pervious concrete section 1300B with an input portion and an output portion. Storage portion 1402 may be configured for providing unfiltered water to the input portion. Optional waterproof gasket 1404 may be disposed between pervious concrete section 1300B and storage portion 1402 so as to prevent or reduce the flow of unfiltered water long the interface between pervious concrete section 1300B and storage portion 1402. Collector portion 1406 may be provided for receiving filtered water from pervious concrete section 1300B.

What is claimed is:

1. A water filter for producing potable water, the water filter comprising:
a pervious concrete section having an input portion and an output portion, the input portion for providing unfiltered water to the pervious concrete section, and the output portion for receiving filtered water from the pervious concrete section and providing the filtered water to a location for collection as the potable water.

2. A water filter in accordance with claim 1, wherein the pervious concrete section includes sand, pebbles, and concrete to hold the sand and pebbles together.

3. A water filter in accordance with claim 2, wherein the pebbles include sieved gravel sized up to about 0.25 inches.

4. A water filter in accordance with claim 2, wherein the pebbles include unsieved gravel sized above about 0.25 inches.

5. A water filter in accordance with claim 2, wherein the sand, the pebbles, and the concrete are held together without a separate container.

6. A water filter in accordance with claim 1, wherein the input portion of the pervious concrete section has size of about 10 inches by 10 inches.

7. A water filter in accordance with claim 6, wherein the input portion and the output portion have a depth therebetween of about 18 inches.

8. A water filter in accordance with claim 1, wherein the pervious concrete section forms pores having a size determined by a ratio of at least one of sand, cement and fly ash to pebbles.

9. A water filter in accordance with claim 8, wherein the pores of the pervious concrete section are configured to remove bacteria sized from about 2 micrometer diameter from the potable water.

10. A water filter in accordance with claim 8, wherein the pores of the pervious concrete section is configured to remove organisms sized larger than a virus from the potable water.

11. A water filter in accordance with claim 1, wherein the pervious concrete section includes recycled concrete material from a previously used pervious concrete section.

12. A water filter in accordance with claim 1, wherein the pervious concrete section includes at least a portion thereof previously exposed to one of chemicals and solar radiation so as to remove impurities from the pervious concrete section.

13. A water filter in accordance with claim 1, wherein the pervious concrete section includes zeolites.

14. A water filter in accordance with claim 1, wherein the zeolites are configured to aid in removal of chemicals from the unfiltered water through the pervious concrete section.

15. A water filter in accordance with claim 1, wherein the zeolites are configured to provide nano-scale porosity to aid in removal of viruses from the unfiltered water through the pervious concrete section.

16. A water filter in accordance with claim 1, wherein the pervious concrete section is configured to substantially neutralize acidic waters from the input region to the output region.

17. A water filter in accordance with claim 1, wherein the pervious concrete section is configured to remove bacteria sized from about 2 micrometer diameter from the potable water.

18. A water filter in accordance with claim 1, wherein the pervious concrete section is configured to remove organisms sized larger than a virus from the potable water.

19. A method of producing potable water with a filter, the method comprising:
providing unfiltered water to an input portion of a pervious concrete section of the filter;
receiving filtered water from an output portion of the pervious concrete section of the filter; and
providing the filtered water to a location for collection as the potable water.

20. A method in accordance with claim 19, further comprising removing impurities from the pervious concrete section of the filter.

21. A method in accordance with claim 20, wherein the step of removing impurities from the pervious concrete section of the filter includes recycling at least portions of the pervious concrete section of the filter.

22. A method in accordance with claim 20, wherein the step of removing impurities from the pervious concrete section of the filter includes exposing at least portions of the pervious concrete section of the filter to chemicals.

23. A method in accordance with claim 20, wherein the step of removing impurities from the pervious concrete section of the filter includes exposing at least portions of the pervious concrete section of the filter to solar radiation for an amount of time necessary to remove the impurities.

24. A method in accordance with claim 19, further comprising forming pores having a size determined by a ratio of at least one of sand, cement and fly ash to pebbles prior to the step of providing unfiltered water to the input portion of the pervious concrete section of the filter, wherein the pores are sized to at least one of (1) remove bacteria sized from about 2 micrometer diameter from the potable water, and (2) remove organisms sized larger than a virus from the potable water.

25. A method in accordance with claim 19, further comprising adding zeolites to the pervious concrete section prior to the step of unfiltered water to the input portion of the pervious concrete section of the filter.

26. A system for producing potable water, the system comprising:
a water filter having a pervious concrete section with an input portion and an output portion;
a storage portion for providing unfiltered water to the input portion of the pervious concrete section; and
a collector portion for receiving filtered water from the output portion of the pervious concrete section so as to provide the potable water.
